(19) United States
(12) Patent Application Publication
(10) Pub. No.: US 2013/0009588 A1
(43) Pub. Date: Jan. 10, 2013

(54) DRIVE CONTROLLING APPARATUS AND DRIVE CONTROLLING METHOD FOR STEPPING MOTOR, DRIVE CONTROLLING SYSTEM, AND OPTICAL APPARATUS

(75) Inventor: Kazutoshi KAWADA, Utsunomiya-shi (JP)

(73) Assignee: CANON KABUSHIKI KAISHA, Tokyo (JP)

(21) Appl. No.: 13/537,250

(22) Filed: Jun. 29, 2012

(30) Foreign Application Priority Data
Jul. 4, 2011 (JP) 2011-148510

(51) Int. Cl. H02P 8/34

(52) U.S. Cl. 318/696

(57) ABSTRACT

A drive controlling apparatus includes a driver configured to apply driving signals configured to excite a plurality of windings in a stepping motor, and a controller configured to acquire a detection result of excitation currents in the windings, and to provide a feedback control over the driving signals so that a difference can be reduced between a first time difference and a second time difference, the first time difference being a period from a first reference time set in an excitation current waveform of the winding corresponding to a first drive channel to a time at which a set current value is provided, and the second time difference being a period from a second reference time corresponding to the first reference time and set in the excitation current waveform of the winding corresponding to the second drive channel to a time at which the set current value is provided.

### BACKGROUND OF THE INVENTION

1. Field of the Invention

The present invention relates to a drive controlling apparatus and drive controlling method for a stepping motor, a drive controlling system, and an optical apparatus.

2. Description of the Related Art

When a stepping motor drives an object to be driven, vibrations and driving noises occur due to manufacturing errors of the stepping motor but reducing or eliminating the manufacturing errors are difficult and increase the cost. Hence, restraining the vibrations by controlling driving in accordance with the manufacturing errors of the stepping motor is proposed, and it is thus necessary to detect the manufacturing errors (vibration amount).

For example, in order to avoid the resonance phenomena of a stepping motor, Japanese Patent Laid-Open No. (“JP”) 2010-004592 discloses a method for detecting its current waveform, and for driving the stepping motor using current values that enable a dispersive ratio of the area for each period of the current waveform can become a reference value or less.

However, JP 2010-004592 requires a long processing time to acquire the dispersive ratio of the area for each period of the current waveform, and must utilize a high-end processor, causing the size and the cost of the drive controlling apparatus to increase.

### SUMMARY OF THE INVENTION

The present invention provides a drive controlling apparatus and drive controlling method for a stepping motor, a drive controlling system, and an optical apparatus, which can reduce vibrations of the stepping motor using a simple structure.

A drive controlling apparatus according to the present invention for a stepping motor includes a driver configured to apply driving signals configured to excite a plurality of windings in the stepping motor, and a controller configured to acquire a detection result of excitation currents that flow in the plurality of windings in the stepping motor, and to provide a feedback control over the driving signals applied by the driver so that a difference can be reduced between a first time difference and a second time difference, the first time difference being a period from a first reference time set in an excitation current waveform of the winding corresponding to a first drive channel to a time at which a set current value is provided, and the second time difference being a period from a second reference time corresponding to the first reference time and set in the excitation current waveform of the winding corresponding to the second drive channel to a time at which the set current value is provided.

Further features of the present invention will become apparent from the following description of exemplary embodiments with reference to the attached drawings.

### BRIEF DESCRIPTION OF THE DRAWINGS

FIG. 1 is a block diagram of an image pickup apparatus (optical apparatus) according to first and second embodiments.

FIG. 2 is a perspective view of a stepping motor for a focusing lens illustrated in FIG. 1 according to the first and second embodiments.

FIGS. 3A-3D each illustrates a relationship between stator magnetic poles and rotor magnetic poles according to the first and second embodiments.

FIG. 4 is a circuit diagram illustrating one example of a current detector illustrated in FIG. 1 according to the first and second embodiments.

FIG. 5 is a circuit diagram illustrating another example of a current detector illustrated in FIG. 1 according to the first and second embodiments.

FIGS. 6A and 6B are waveform diagrams of the driving current for the stepping motor illustrated in FIG. 2 according to the first and second embodiments.

FIGS. 7A and 7B are waveform diagrams for explaining a method of correcting the excitation current according to the first and second embodiments.

FIG. 8 is a flowchart for explaining operations of a microprocessor illustrated in FIG. 1 according to the first embodiment.

FIG. 9 is a flowchart of correcting processing 1 illustrated in FIG. 8 according to the first embodiment.

FIG. 10 is a graph illustrating a relationship between the correction of a phase difference and a vibration amount according to the first embodiment.

FIG. 11 is a graph illustration a vibration reducing characteristic of the driving waveform correction according to the first embodiment.

FIG. 12 is a flowchart for explaining a drive controlling method of a stepping motor executed by a microprocessor according to the second embodiment.

FIG. 13 is a block diagram of a drive controlling system according to a third embodiment.

### DESCRIPTION OF THE EMBODIMENTS

A description will be given of a variety of embodiments of the present invention with reference to the accompanying drawings.

### First Embodiment

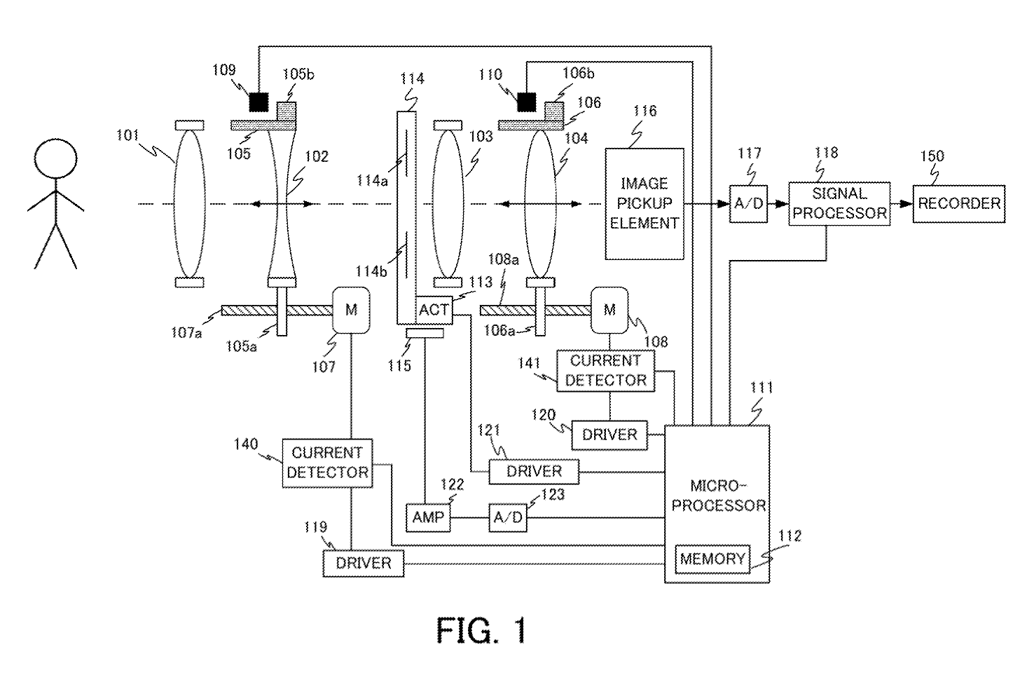

FIG. 1 is a block diagram of an image pickup apparatus (optical apparatus), such as a digital still camera and a video camera, according to a first embodiment. An apparatus to which the present invention is applicable is not limited to the image pickup apparatus, and includes other apparatuses, such as a lens barrel (optical apparatus) that can be attached to and detached from the camera body, an industrial robot, an automobile component, a gaming machine, such as a pachinko and a game, and an office machine, such as a scanner, a printer, and a copier.

The image pickup apparatus illustrated in FIG. 1 includes an image pickup optical system that includes, in order from the object side, a field lens 101, a magnification-varying lens (zoom lens) 102, a light quantity adjusting (diaphragm) unit 114, an afocal lens 103, and a focusing lens 104. The image pickup optical system is a rear focus type zoom lens configured to form an optical image of an object, but this embodiment is not limited to this structure.

The magnification-varying lens 102 is held by a lens holding frame 105, and the focusing lens 104 is held by a lens holding frame 106. The lens holding frames 105 and 106 are configured movable in the optical axis direction (an arrow direction in FIG. 1) by guide shafts (not illustrated).

A rack 105a is attached to the lens holding frame 105, and a rack 106a is attached to the lens holding frame 106. The racks 105a and 106a are mated with screw shafts 107a and 108a as output shafts of the stepping motors 107 and 108. When each stepping motor is driven and its screw shaft is rotated, the lens holding frame to which the rack is attached is moved in the optical axis direction by the engagement between the screw shaft and the rack.

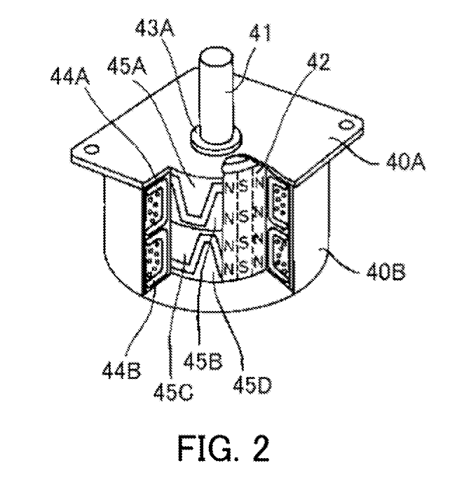

FIG. 2 is a perspective view of the stepping motor 108 for the focusing lens 104. The stepping motor 108 is, for example, a PM type two-phase stepping motor, and FIG. 2 illustrates the inside of the stepping motor 108 by partially cutting it. However, the number of channels is not limited to two.

In FIG. 2, reference numeral 41 denotes an (output) shaft of the stepping motor, and reference numeral 42 denotes a magnet rotor integrated with the shaft 41. The shaft 41 is rotatably supported by a bearing 43A provided to the case 40A and a bearing (not illustrated) provided to the case 40B.

The bobbins 44A and 44B wound by the coils are housed in the case 40B, and the comb-shaped stators 45A, 45B, 45C, and 45D are arranged inside of the bobbins 44A and 44B.

The PM type two-phase stepping motor includes a plurality of (or two) coil windings on the stator side, and switches an excitation pattern of a driving signal (voltage or current) for exciting the wiring. Thereby, an excitation pole is switched between the stator and the rotor, and the rotor is rotated as this switching is repeated.

Assume that the two drive channels are referred to as A-channel and B-channel, and that in order to identify the current flowing direction, the forward directions are expressed by A and B and the backward directions are expressed by /A and /B. Then, a one-phase driving method always excites only one channel in order of A, B, /A, and /B. The one-phase driving method can lower the calorific value since the consumed excitation power is always limited to only one phase but the generated driving torque is too small to fast rotations.

On the other hand, two-phase driving method simultaneously excites two drive channels by shifting one pulse in order of (/B+A), (A+B), (B+/A), and (/A+/B). Although this method can acquire a torque larger than that of the one-phase driving method, the excitation current becomes double.

Since both of these two driving methods provide a rotation by an angle corresponding to a neighboring magnetic pole interval whenever one pulse is provided, the minimum rotating angle is characteristically large. It is difficult to make it finer due to the mechanical processing precision.

A one-two phase driving method improves them utilizing a control method. This is a method that alternately executes the one-phase driving method and the two-phase driving method, and enables the resolution of a stop position to be half that of each the one-phase driving method and the two-phase driving method, characteristically realizing fine angular control.

On the other hand, the stepping motor has a problem of large rotational vibrations.

A first cause is a torque ripple vibration of the rotor when it follows the excitation pulse. The stepping motor rotates in synchronization with a pulsed excitation control signal, and when an excitation angle becomes faster by one step angle, the rotator accelerates and tries to follow the excitation angle. When the rotor angle accords with the excitation angle, the rotor rotating speed reaches its peak and cannot stop immediately and the rotor inevitably goes past. Then, it tries to return the excitation position again. By repeating this, it finally accords with the excitation angle. This phenomenon generates a vibration component caused by the characteristic vibration of the rotor, and these rotor vibrations are continuously repeated and cause the rotational vibrations of the motor in the continuous rotations.

A second cause is a manufacturing error of an individual motor. Driving of the stepping motor is controlled by the open-loop method and the excitation driving signal is designed on the premise that the motor has the ideal magnetic pole arrangement. However, it is difficult to improve the manufacturing precision in the PM type stepping motor, etc. Moreover, when the motor becomes smaller due to the demand for the miniaturization, the size precisions required for the magnetic positions of the stator and the rotor become stricter but the excitation angle error of the magnetic pole arrangement to the excitation driving signal increases under the same manufacturing precision level. The vibration amount of the motor increases with the error amount.

For example, one step corresponds to 9° shaft rotating angle in the PM type of stepping motor in which there are 40 excitation steps per one rotor shaft rotation (one-two phase count). One step corresponds to an excitation angle of 45°. An excitation angle of 1° is a rotor angle of 0.2°, and the size precision of the magnetic pole cog is 0.0077 mm on the stator side in the motor having an outer diameter of Φ8 mm and the diameter of the stator is about 4.4 mm.

When the precision corresponding to the excitation angle of 1° is necessary, the stator side precision of 0.0077 mm is necessary but this condition causes the cost to increase because the precision of the manufacturing tool and the precision of the inspection in the post-assembly sorting are required to improve.

One step in the stepping motor in this embodiment corresponds to a rotating angle of 9°. Thus, the rotor 42 is magnetized with 10 pairs of N poles and S poles. The stators 45A to 45D overlap one another in the axial direction while they shift with an angular difference of 9° in the circumferential direction.

The coils wound around the bobbins 44A and 44B are used to flow the excitation current so as to make the magnetic pole in each stator (comb portion). The coil wound around the bobbin 44A is referred to as an A-channel coil and used to excite the stators 45A and 45B. The coil wound around the bobbin 44B is referred to as a B-channel coil and used to excite the stators 45C and 45D.

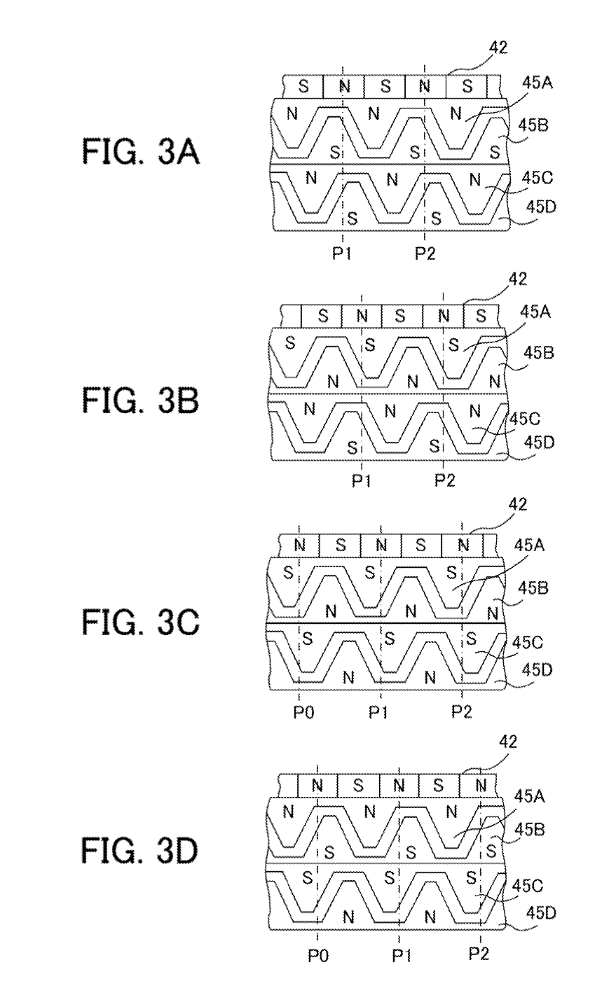

FIGS. 3A to 3D illustrate positional relationships between the stator magnetic poles and the rotor in the two-phase driving method.

FIG. 3A illustrates a state in which the excitation current is flowed in the forward direction in each of the A-channel coil and the B-channel coil. In this state, the stator 45A is magnetized with the N pole, the stator 45B is magnetized with the S pole, the stator 45C is magnetized with the N pole, and the stator 45D is magnetized with the S pole.

When the position of the S pole on the stator side is addressed, the center of the S pole is the positions illustrated by P1 and P2 in FIG. 3A corresponding to the center position between the comb portion of the stator 45B and the comb portion of the stator 45D, and the N pole of the rotor 42 is stable at the opposite positions.

FIG. 3B illustrates a state in which the excitation current flows in the opposite direction in the A-channel coil while the excitation current flows in the B-channel coil in the same direction in comparison with FIG. 3A. In this state, since the stator 45A is magnetized with the S pole and the stator 45B is magnetized with the N pole, the centers P1 and P2 of the S pole on the stator side rotate by 9° and the N pole of the rotor also rotates by 9° accordingly.

Similarly, as illustrated in FIGS. 3C and 3D, the center of the S pole on the stator can be rotated by 9° each time by switching the directions of the excitation currents flowing in the A-channel and B-channel coils, and the rotor 42 can be consequently rotated by 9° each time.

The stepping motor 107 is driven by the driver 119, and the stepping motor 108 is driven by the driver 120. Each driver supplies the excitation signal (excitation current or voltage) to the A-channel coil and the B-channel coil in each stepping motor in accordance with the drive controlling signal from the microprocessor 111. For instance, the drivers 119 and 120 apply driving signals for exciting the plurality of coil windings from a DC power source.

The diaphragm unit 114 includes a so-called galvano-type diaphragm motor 113, diaphragm blades 114a and 114ab opened and closed by the diaphragm motor 113, a position detector (Hall element) 115 configured to detect the opening and closing states of the diaphragm blades 114a and 114b.

An analog signal that is output from the position detector 115 and indicative of the opening and closing state of the diaphragm unit 114 is amplified by an amplifier 122, converted into the digital signal by an A/D converter 123, and input as diaphragm position information into the microprocessor 111.

Reference numeral 116 is an image pickup element, such as a CCD sensor and a CMOS sensor, configured to photoelectrically convert an object image formed by the image pickup optical system. The analog signal output from the image pickup element 116 that has photoelectrically converted the object image is converted into a digital signal by an A/D converter 117 and the digital signal is input into a signal processor 118.

The signal processor 118 provides various image processing for an input digital signal and generates captured image data and its brightness information. The captured image data is recorded in the recording medium (not illustrated) by a recorder 150.

The microprocessor 111 as a controller controls the entire operations of the image pickup apparatus in accordance with inputs through a power switch, a recording switch, a zoom switch, etc.

For example, the microprocessor 111 provides a feedback control over the diaphragm motor 113 so that the brightness information obtained by the signal processor 118 can be a proper value. The microprocessor 111 sends an opening/closing control signal to a diaphragm driver 121 so that the brightness information can be a proper value based on the diaphragm position information from the A/D converter 123, and controls the diaphragm motor 113.

In addition, magnification-varying of the image pickup optical system and correcting of associative image plane variations are performed by controlling driving of the stepping motors 107 and 108 using the so-called electronic cam method using cam locus data stored in an internal memory 112 in the microprocessor 111. In the meanwhile, the driving method of each stepping motor is not limited.

The microcomputer 111 controls driving over the drivers 119 and 120 for the stepping motors by providing them with the drive controlling signals. A current detector 140 is provided between the driver 119 and the stepping motor 107 and configured to detect the excitation current that flows in the plurality of coil windings of the stepping motor 107. A current detector 141 is provided between the driver 120 and the stepping motor 108 and configured to detect the excitation current that flows in the plurality of coil windings of the stepping motor 108. The detection results of the current detectors 140 and 141 are sent to the microprocessors 111.

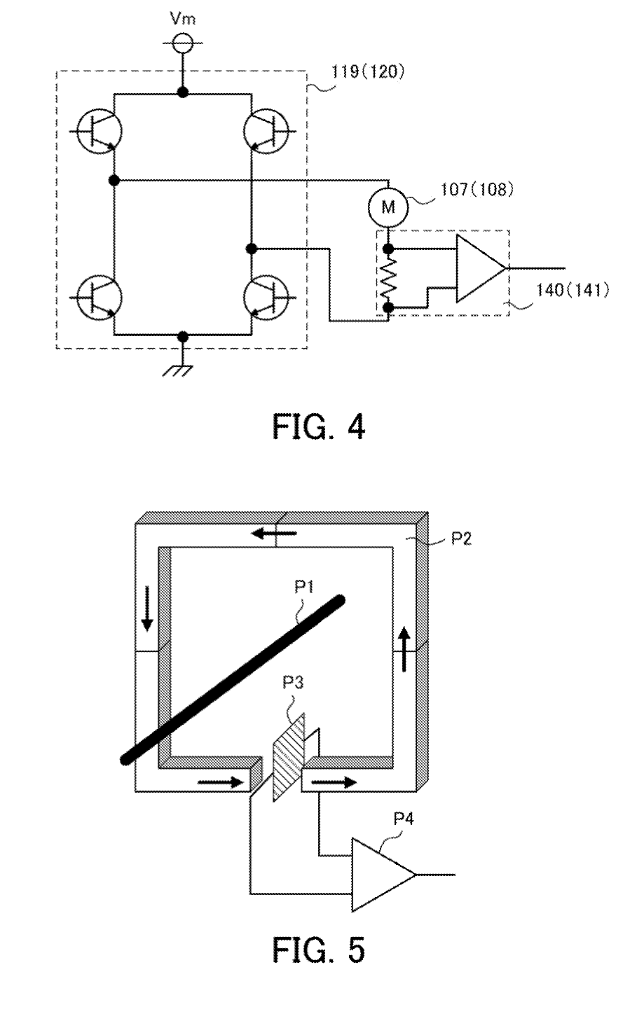

FIGS. 4 and 5 illustrate concrete structural examples used for the current detectors 140 and 141.

FIG. 4 is a circuit diagram of the current detector 140 (or 141) using the series resistor method. This circuit illustration provides micro-step driving using a pulse width modulation (“PMW”) and thus the driver 119 (or 120) includes four H-bridged transistors. A resistor is inserted in series between the stepping motor 107 (or 108) and the current detector 140 (or 141).

In general, a resistance value is restrained small so as to reduce the influence on the driver system caused by the insertion of the resistor. The voltage between both terminals of this resistor is amplified up to a desired voltage value by a differential amplifier, and then measured by an A/D converter installed in the microprocessor 111 (or the A/D converter 123).

FIG. 5 illustrates a current detector that uses a Hall element. It is a detector that utilizes wiring P1 that connects the driver and the terminal of the stepping motor to each other passes a magnetic loop core P2 made of ferrite core, etc., and converts a magnetic flux amount generated by the current flowing in the wiring P1 into a voltage value using a Hall element P3. Even in this circuit, the detected voltage value is generally small, amplified by a differential amplifier P4, and then measured by the A/D converter (not illustrated) similar to the series resistor method.

A sampling period of the A/D converter herein is required to be enough large for the current waveform detecting purpose, and an illustrative sampling period which enables the approximation degree of the current waveform to be determined is 100 times as large of one period of the current waveform.

The microprocessor 111 corrects a driving signal supplied to each channel of the stepping motor so as to reduce the vibration amount of the motor based on the detection results of the current detectors 140 and 141.

The internal memory 112 in the microprocessor 111 stores a drive controlling program for the stepping motor, a drive correcting parameter, etc. The internal memory 112 also stores positional data of the focusing lens 104 determined by the object distance and the position of the zoom lens 102, as the number of steps corresponding to the rotating amount of the stepping motor 108.

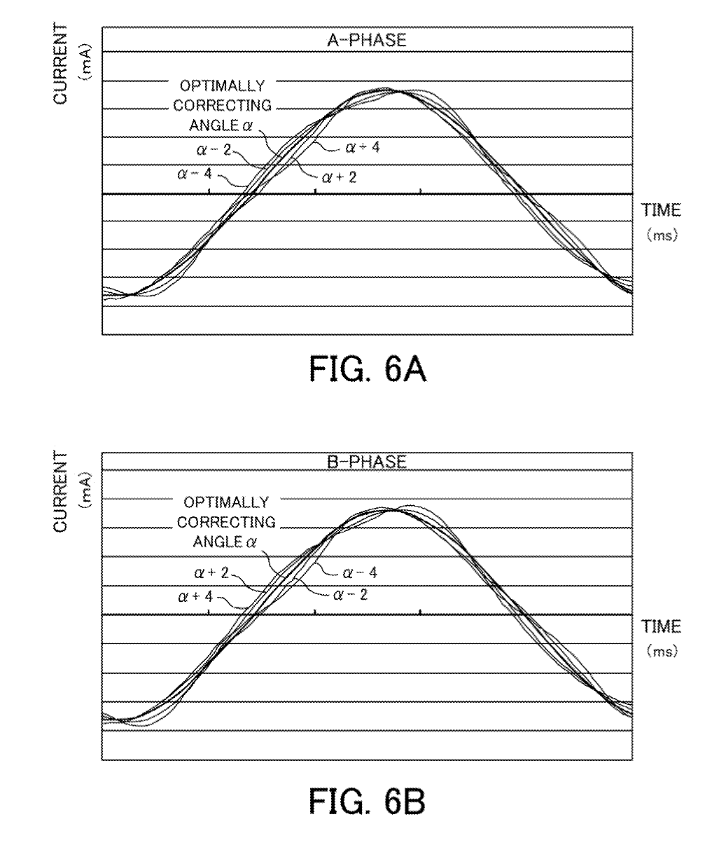

FIGS. 6A and 6B are waveform diagrams of the A-channel and the B-channel when the motor driving signal is corrected. The abscissa axis denotes time (ms), and the ordinate axis denotes current (mA). The stepping motor is a two-phase PM type stepping motor, and the correction of the driving signal changes a phase difference between the excitation signals provided to the two phases of the A-channel and the B-channel.

FIGS. 6A and 6B are current waveform diagrams made by measuring the driving waveforms in which a phase difference angle between the A-channel and the B-channel is corrected using five conditions and by overlapping them so that their shape changes can be easily recognized. The excitation current that flows in the stepping motor is generated by a difference between (ideal) driving currents applied by the drivers 119 and 120 and the counter electromotive forces (voltages) generated in the stepping motor by the driving signals.

Although the A-channel shifts from the B-channel by 90°, the time axis is shifted for comparative purposes so that they have the same phase. In FIGS. 6A and 6B, an optimally correcting angle α(°) means an optimal phase difference angle that is generated from the electric excitation angle between the A-channel and the B-channel of the measured motor and a manufacturing error angle. The optimal phase difference angle α is expressed by the following expression using a manufacturing error angle β(°):

α=90°±β (1)

In FIGS. 6A and 6B, “α−2,” “α−4,” “α+2,” and “α+4” correspond to electric waveforms in which the electric excitation angle is changed by 2° and 4° in the ± directions from the optimal phase difference angle α. With respect to the phase difference angle condition and the current waveform shape, the waveforms of the A-channel and the B-channel closely resemble and are close to the ideal sine and cosine waves at the optimally correcting angle α.

The excitation current waveform of the stepping motor indirectly represents a rotating state of the rotor, and indicates an ideal triangular wave shape when the rotor stably rotates at the constant speed with no vibrations. It is nevertheless difficult to realize a stepping motor that rotates with no vibrations, and the rotating speed fluctuates due to the influences of a variety of characteristics of the pulsed motor, such as a stiffness characteristic and a detent characteristic. As a result, the current waveform is distorted to some extent and exhibits the trigonometric function shape.

The position, amount, and direction of the distorted portion represent a matching degree between a required excitation waveform shape that contains a mechanical phase difference caused by the manufacturing error and is optimal to the motor and an applied electric excitation waveform shape. When both excitation waveform shapes are best matched with each other, the A-channel and B-channel current waveforms closely resemble.

Hence, the vibration amount can be reduced by correcting the driving waveform of the stepping motor so that the excitation current waveforms of a plurality of drive channels, such as the A-channel and the B-channel, can closely resemble.

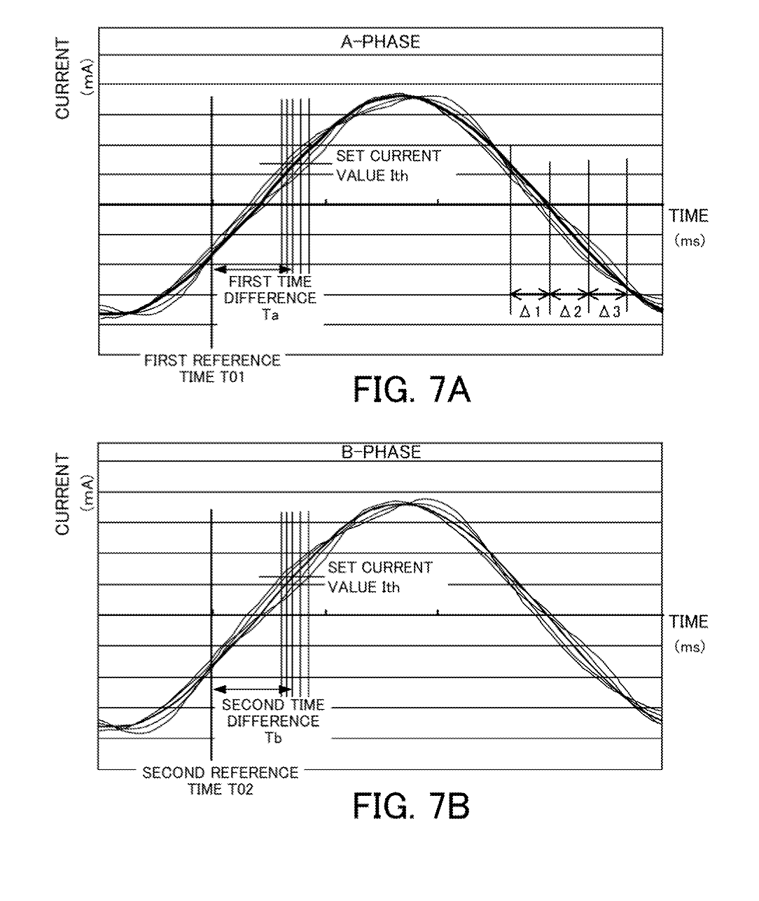

The microprocessor 111 acquires, from the current detectors 140 and 141, the detection results of the excitation currents that flow in a plurality of windings of the stepping motors 107 and 108. Next, the microprocessor 111 matches the phases of the A-channel and the B-channel as illustrated in FIGS. 7A and 7B. In FIG. 7A and 7B, the abscissa axis denotes time (ms), and the ordinate axis denotes the current (mA). In the ideal state, the A-channel is a sine wave, the B-channel is a cosine wave, and thus the phase shifts by 90°, but one of them is shifted relative to the other so as to cancel the shift.

Next, the microprocessor 111 obtains a first time difference Ta from a first reference time T01 that is set in the excitation current waveform of the coil winding corresponding to the A-channel (first drive channel) (and used to provide a predetermined current value) to time at which a set current value Ith is provided.

In addition, the microprocessor 111 obtains a second time difference Tb from a second reference time T02 that corresponds to the first reference time T01, is set in the excitation current waveform of the coil winding corresponding to the B-channel (second drive channel) (and used to provide the above predetermined current value) to time at which the set current value Ith is provided.

Then, the microprocessor 111 controls the driving signals applied by the detectors so as to reduce a difference (|Ta−Tb|) between the first time difference Ta and the second time difference Tb. In this case, the microprocessor 111 may provide a feedback control over the driver so that the difference (|Ta−Tb|) can reduce or so that the ratio (=Ta/Tb) can approach to 1.

In the feedback control, the microprocessor 111 corrects at least one of the phase difference or amplitude ratio between the excitation signals provided to the plurality of channels in the stepping motor, and continues the correction as the difference between Ta and Tb becomes smaller because the direction of the feedback correction is correct. When the value inverts and increases in the difference reducing direction, the extreme value is set to the target value. Therefore, the microprocessor 111 corrects driving so as to return to that position.

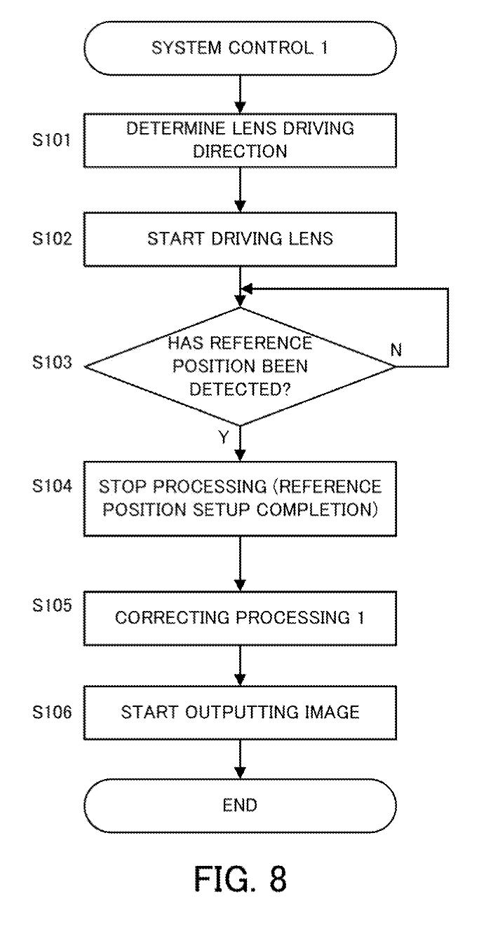

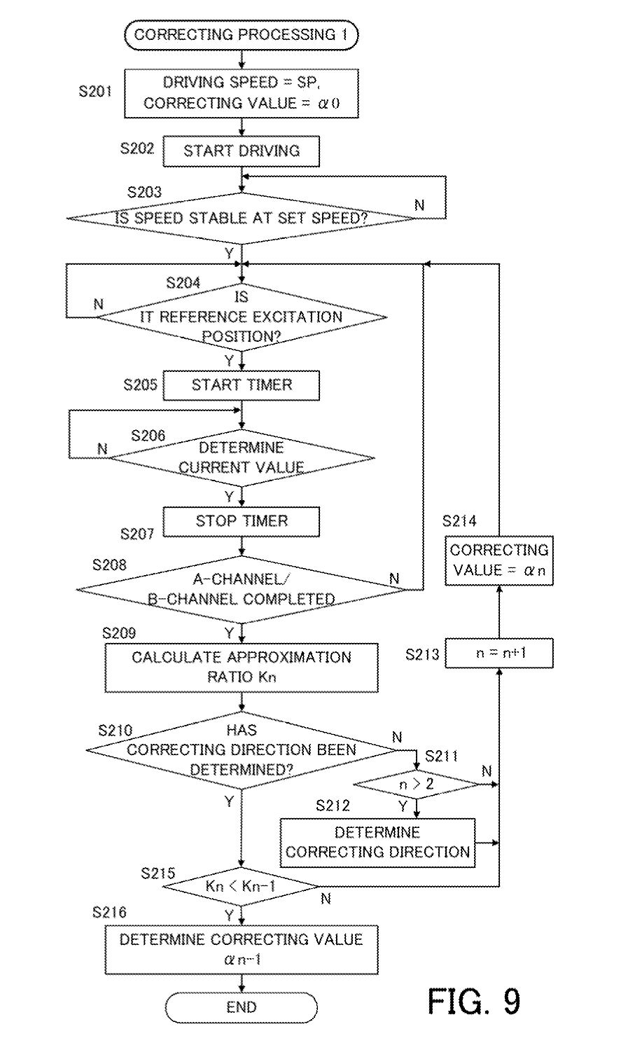

FIGS. 8 and 9 are flowcharts illustrating the drive controlling methods of the stepping motor 107 executed by the microprocessor 111, and “S” stands for the step. This drive controlling method can be implemented by a computer executable program, and this is true of other embodiments.

Herein, the drive controlling signal provided to the driver 119 by the microprocessor 111 determines a phase between the excitation signals supplied to the plurality of channels (A-channel and B-channel) in the stepping motor 107. Therefore, correcting the drive controlling signal means correcting phases of the excitation signals.

This embodiment corrects the drive controlling signal applied to the driver 119 using the motor driving current detection signal acquired by the current detector 140, and thereby reduces the vibrations (driving noises) generated in the stepping motor 107.

When the image pickup apparatus is powered on, the microprocessor 111 performs initialization processing. Thereafter, the microprocessor 111 executes a system control 1 including correcting processing 1 that finds a correcting value (referred to as a “drive correcting value” hereinafter) of the drive controlling signal suitable for the individual characteristic of the stepping motor 107.

Initially, the microprocessor 111 determines the moving direction of the magnification-varying lens 102 (lens driving direction) using a signal from a photo-interrupter 109 (S101), and initiates driving in that direction (S102).

Next, the microprocessor 111 determines whether the magnification-varying lens 102 reaches the reference position as the target position and the signal level from the photo-interrupter 109 changes from High to Low or Low to High (S103).

When the signal level from the photo-interrupter 109 varies, the microprocessor 111 performs driving stop processing of the stepping motor 107 and setting processing of an internal position counter (S104), and completes the reference position setup processing.

Next, the microprocessor 111 performs the correcting processing 1 configured to calculate the drive correcting value as illustrated in FIG. 9 (S105). When completing the correcting processing 1, the microprocessor 111 initiates a display output of captured image data to a back monitor (not illustrated) of the image pickup apparatus (S106). Thus, the system control 1 is completed as an operation when the power is turned on.

A description will be given of the correcting processing 1 illustrated in FIG. 9. In the correcting processing 1, the driver is feedback-controlled so that the current waveforms of the A-channel and the B-channel can closely resemble as in FIGS. 7A and 7B (or so that Ta can be equal to Tb in FIGS. 7A and 7B).

The set current value Ith utilizes a predetermined value so that the distorted amount of the current waveform can be readily detected, but the optimal set current value Ith may be set for the motor by changing Ith during the correcting processing.

Initially, the microprocessor 111 sets the driving speed of the magnification-varying lens 102 to a predetermined speed SP so as to calculate the drive correcting value that enables the driver to properly drive the stepping motor, and sets the drive correcting value to 0 (S201).

The predetermined speed SP may be a predetermined set speed (or a speed within a set range) which enables the vibration amount of the stepping motor illustrated in FIGS. 6A and 6B becomes the predefined amount or larger. Alternatively, the microprocessor 111 may provide a feedback control over the detector based on the current detection result when a difference between the first time difference Ta and the second time difference Tb (=|Ta−Tb|) is larger than the set value. The correcting direction becomes clearly identifiable in these cases.

The driving speed of the magnification-varying lens 102 which is suitable for the characteristic of the individual motor and used to find the drive correcting value may be determined by changing it and by measuring the vibration level.

Next, the microprocessor 111 starts driving the stepping motor 107 so as to move the magnification-varying lens 102 at the set driving speed (S202).

Next, the microprocessor 111 confirms whether the driving speed reached by the acceleration period after the driving starts becomes stable at the constant speed because the vibration amount of the stepping motor 107 can be more stably detected when the driving speed of the magnification-varying lens 102 is maintained constant (S203).

When confirming that the driving speed has become stable, the microcomputer 111 determines whether the excitation position of the excitation current waveform has been reached the reference position (T01 and T02 in FIGS. 7A and 7B) as the measurement condition (S204). By according the reference position on this excitation current waveform when the A-channel is measured, with that when the B-channel is measured, two drive channels having a time difference of an electric excitation angle of 90° can become measured under the same condition. When there are three channels, a shift of 120° is corrected.

The reference positions of at least two drive channels are accorded with each other, the microprocessor 111 starts counting up the timer in the microprocessor 111 (S205).

Next, the microprocessor 111 repeats the determining processing so as to detect the timing at which the current values measured by the current detectors 140 and 141 become the predefined set current value Ith (S206).

The microprocessor 111 stops counting up the timer when detecting the set current value Ith (S207). Then, the microprocessor 111 calculates an elapsed time period (such as a first time difference Ta and a second time difference Tb) from the reference position (the first reference time T01 or the second reference time T02) to the point that provides the set current value Ith.

The set current value Ith may be a predefined value that enables the current waveform shape to significantly change as the vibration amount of the motor increases or decreases or a current value that enables a measurement time period to significantly change as the driving phase difference angle changes in the correcting processing.

Next, the microprocessor 111 determines whether measurements of all drive channels of which current waveform shapes are compared are completed (S208). When all the drive channels have not yet been measured, the flow returns to S204 and when all the drive channels have been measured, the microprocessor 111 calculates a approximation ratio Kn of the current waveform based upon the measured elapsed time period (S209) and stores it.

While this embodiment finds the approximation ratio Kn (=100×Ta/Tb), another embodiment finds the time difference (=|Ta−Tb|). In any event, it is sufficient to adjust the drive correcting value so that the current waveforms of respective drive channels can be close to one another (or a difference between the first time difference Ta and the second time difference Tb can be reduced).

Next, the microprocessor 111 determines whether the (correcting) direction in which the drive correcting value is changed has been determined (S210) necessary for the determining process of the proper driving correcting amount by gradually changing the drive correcting value.

Since the correcting direction has not yet been determined when the correction is just started, the microprocessor 111 calculates the approximation ratio Kn a plurality of times (for example, twice), and determines the correcting direction in which the approximation ratio Kn increases relative to a change of the drive correcting value (S210).

When the correcting direction is determined (S210), the microprocessor 111 compares the current approximation ratio Kn with the just previous approximation ratio Kn−1 (S215). When the current approximation ratio Kn is smaller than the just previous approximation ratio Kn−1, the microprocessor 111 acquires the drive correcting value αn−1 that provides the past maximum approximation ratio, determines this as the drive correcting value (S216), and ends the correcting processing 1.

On the other hand, when the current approximation ratio Kn is larger than the just previous approximation ratio Kn−1, the microprocessor 111 changes the drive correcting value to the determined correcting direction so as to obtain the best drive correcting value (S213, S214), and returns to S204.

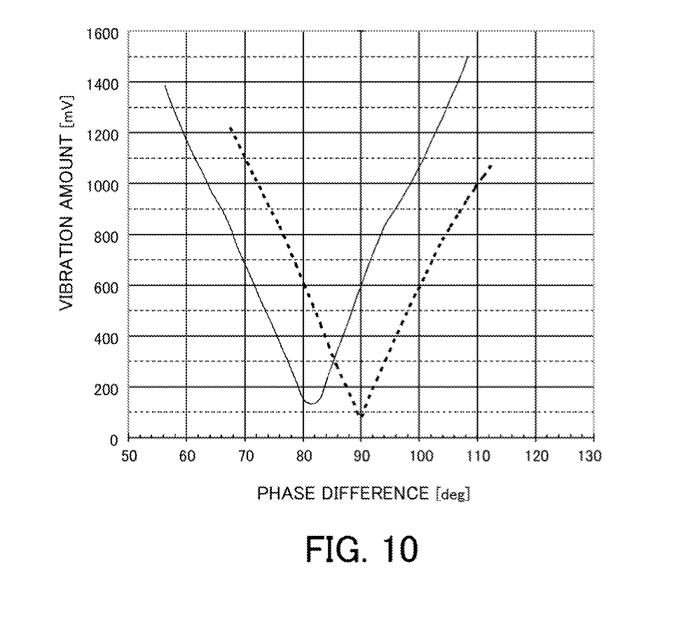

FIG. 10 illustrates a relationship between a phase difference (°) between the A-channel and the B-channel and (abscissa axis) and the vibration amount (mV) of the stepping motor 107 (ordinate axis) when the phase difference (°) between the A-channel and the B-channel as the driving correcting parameter is changed. A solid line and a broken line in FIG. 10 illustrate measurement results of two motor samples as the stepping motor 107.

As understood from the measurement result, the drive correcting value proper to the stepping motor can be acquired by gradually changing the drive correcting value (phase difference between the A-channel and B-channel excitation signals) in the direction in which the vibration amount of the stepping motor decreases, and by detecting the driving correction value that minimizes the vibration amount.

In this way, the driving correcting signal is corrected by utilizing the drive correcting value that is determined to provide a maximum value of the approximation ratio Kn or in other words, the driving of the stepping motor 107 is controlled by utilizing the driving correction value. Thereby, the stepping motor 107 can be driven in a way suitable for the individual characteristic of the stepping motor 107, and the vibrations and associating noises of the stepping motor 107 when it is driven can be reduced.

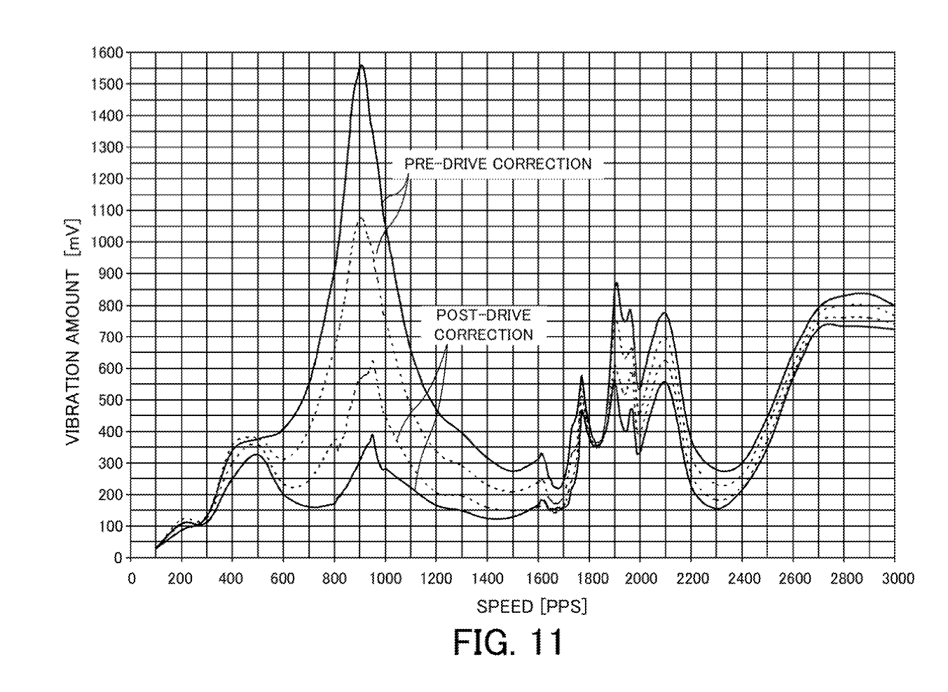

FIG. 11 illustrates a vibration reduction effect of the stepping motor when the phase difference between the excitation signals provided to the two channels in the PM type two-phase stepping motor is corrected by the method described in this embodiment. The abscissa axis denotes a driving frequency (PPS) corresponding to the rotating speed of the stepping motor, and the ordinate axis denotes a vibration amount (mV). Solid and broken lines in FIG. 11 are measurement results of the two motor samples as the stepping motor 107.

As understood from FIG. 11, the vibrations are effectively reduced over the entire range of the driving speed before and after the drive correction. In particular, the vibration amount of the post-drive correction is approximately quartered near the driving speed of 900 PPS that is a peak of the vibration amount in the pre-drive correction.

This embodiment can reduce the vibration amount of the stepping motor.

### Second Embodiment

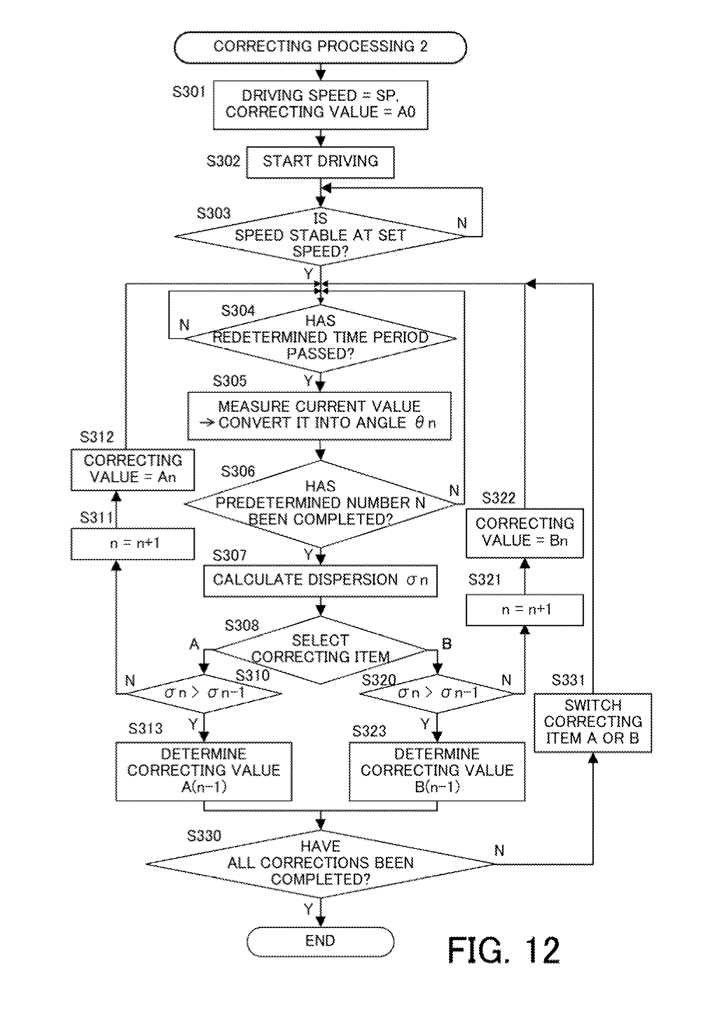

FIG. 12 is a flowchart illustrating a drive controlling method (correcting processing 2) of a stepping motor according to a second embodiment, and “S” stands for the step. The structure of the image pickup apparatus of this embodiment is the same as that of the first embodiment (FIG. 1).

The correcting processing 2 is performed instead of the correcting processing 1. The correcting processing 2 corrects a plurality of correcting items relating to the drive controlling signal of the stepping motor, and further reduces the vibration amount of the stepping motor.

In the correcting processing 2, the microprocessor 111 detects the vibration amount of the stepping motor utilizing a method different from that of the first embodiment. In other words, the microprocessor 111 acquires the excitation current values of the A-channel and the B-channel in the stepping motor as digital data through A/D conversions at predetermined time intervals. Approximately simultaneous sampling of the A/D conversion is required between the A-channel and the B-channel, but the sampling may be sequentially performed due to the restraints of the number of channels of the A/D converter. Accordingly, the correcting processing 2 adopts a calculating method in which the measurement precision does not deteriorate even when there is a sampling time difference.

Since the processing from S301 to S303 in FIG. 12 is the same as that from S201 to S203 in FIG. 9, and a description thereof will be omitted.

After S303, the microprocessor 111 measures a time to A/D-convert the current waveform at the predetermined time intervals (S304). At the A/D conversion sampling timing, the microprocessor 111 instructs a start of the A/D conversion, and the driving current values of the A-channel and the B-channel in the stepping motor are converted into digital data (S305).

The converted current values of the A-channel and the B-channel are converted into the angles θBn and θAn on the trigonometric function by arcsine (ASIN) and arccosine (ACOS). The two outputs of the A-channel and the B-channel can mutually interpolate a drop of the detecting precision caused by the attenuation of an output variation amount per an angular variation amount in the trigonometric function every 180° periods.

In order to precisely calculate the angle θn on the trigonometric function utilizing a plurality of current waveforms the moment the sampling is performed, the A/D conversion among data is sampled at the same timing. However, a certain constant time shift is permissible for the sufficient precision by utilizing the following expression and two angular data θBn and θAn:

θn=(θBn+θAn)/2 (2)

Next, the microprocessor 111 determines whether the data acquisition of the rotating angle θn of the stepping motor 107 has been repeated a plurality of times (N times or ten times in this embodiment) (S306), and returns to S304 if it has not yet been repeated the N times. If it has been repeated the N times, the microprocessor 111 calculates the dispersion σₙ of N rotating angle data θn (S307).

The dispersion (standard deviation) σₙ is a value representing a level of a variation amount of a plurality of acquired error data Δθn, and as the dispersion σₙ is small, a variation amount of the rotating angle per a predetermined time period is small or the vibration amount caused by the rotational variation is small. Herein, θₐᵥₑ is an average value of N rotating angle data θn.

σₙ=√(1/N·Σ(θₙ−θₐᵥₑ)²) (3)

For example, as illustrated by the A-channel in FIGS. 7A and 7B, rotating angles (such as 10°, 12°, 8°, . . . ) of the stepping motor are obtained at a plurality of periods (Δ1, Δ2, Δ3, . . . ) set in the excitation current waveform of one winding (A-channel coil winding). The plurality of time periods have the same time difference (Δ=Δ1=Δ2=Δ3 . . . ). In the ideal state, the rotating angle in each period is equal (to, for example, 10°), and the drive correcting amount is determined so that the measured rotating angles become equal to one another.

In order to definitely detect the correcting direction, even this embodiment may provide a feedback control over the driver based on the current detection result when the variation amount of the rotating angle of the stepping motor is larger than the set value.

Next, the microprocessor 111 selects the correcting object items to be actually corrected among a plurality of correcting items (S308). Herein, it is selected in the correcting items A and B.

For example, the correcting item A may be a phase difference between the excitation signals applied to the A-channel and the B-channel in the stepping motor 107 described in the first embodiment, and the correcting item B may be set to the amplitude ratio of the excitation signal. As another correcting item, the excitation signals applied to the A-channel and the B-channel in the stepping motor 107 may be corrected in the shape of the trigonometric function, such as a sine wave, in which the 180° position relative to the 0° position is shifted for each drive channel.

When the correction item A is selected as the correcting object item, the microprocessor 111 compares the currently calculated dispersion value σₙ with the just previously calculated dispersion value σₙ₋₁ (S310). In case of σₙ<σₙ₋₁, the microprocessor 111 repeats an evaluation of the next drive correcting value of the correcting item A (S311 and S312).

Although not illustrated, the correcting direction of the first embodiment has already been determined. On the other hand, in case of σₙ>σₙ₋₁, a proper drive correcting value is exceeded. Therefore, the microprocessor 111 determines the just previous drive correcting value as an appropriate drive correcting value Aₙ₋₁ for the stepping motor 107 (S313), and completes a correction of the correcting item A.

Next, the microprocessor 111 determines whether the corrections have been completed for all the plurality of correcting items (S330), switches the current correcting item to the remaining correcting item (which is the correcting item B) if it has not yet been completed (S331), and returns to S304.

The drive controlling signal is corrected by the drive correcting value in each correcting item determined so that the variations of the rotating angle data θn can be minimized, and the driving of the stepping motor 107 is controlled. Thereby, the vibration amount of the stepping motor can be reduced.

### Third Embodiment

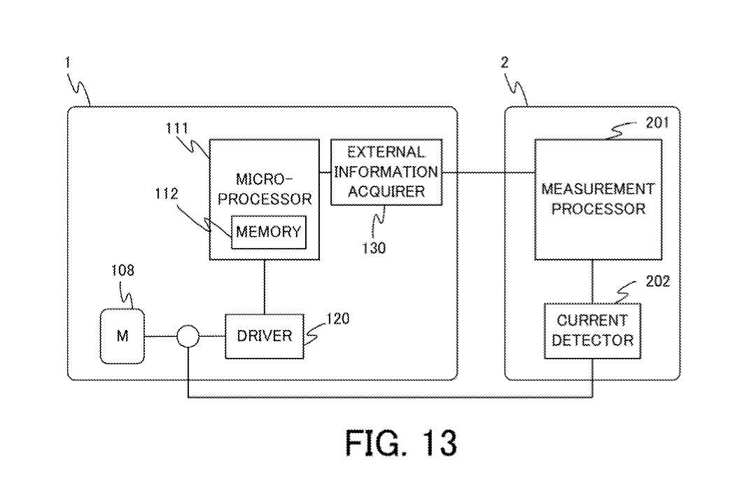

FIG. 13 is a block diagram of a drive controlling system that includes an image pickup apparatus and a measurement apparatus according to a third embodiment. The image pickup apparatus (optical apparatus) is configured similar to that of the first embodiment (FIG. 1) but it has no current detector and includes an external information acquirer 130 instead.

In this embodiment, the measurement apparatus 2 that is separately provided from the image pickup apparatus 1 detects the driving current of the stepping motor installed in the image pickup apparatus 1. The image pickup apparatus 1 determines a drive correcting value appropriate to the stepping motor and the corresponding correcting items, and reduces the vibration amount of the stepping motor based on the detection result of the measurement apparatus 2 obtained via the external information acquirer 130

The external information acquirer 130 serves to communicate with an external unit of the image pickup apparatus 1, and may be realized by (but not limited to) a communication circuit, such as USB, ETHER, RS232C, etc., and a data input/output circuit using a memory.

The measurement apparatus 2 includes a current detector 202 configured to measure the driving current to the stepping motor 108 output from the driver 120, like the current detectors 140, 141 of the first embodiment. A measurement processor 201 obtains driving current information of the stepping motor detected by the current detector 202 and provides it to the image pickup apparatus 1.

In operation, the microprocessor 111 starts driving the stepping motor 108 under the predefined driving condition, and the measurement apparatus 2 measures the current at predetermined timing during driving. The current value detected by the current detector 202 is A/D-converted by the measurement processor 201 every a predetermined period, and the microprocessor 111 acquires driving current of the stepping motor as digital data via the external information acquirer 130.

The microprocessor 111 calculates the driving condition that enables the vibration amount of the motor can reduce, based on the acquired driving current information and the method for calculating the drive correcting value optimal to the individual motor, and the microprocessor 111 stores the result in the internal memory 112. Thereby, the image pickup apparatus 1 can be singularly used thereafter without the measurement apparatus 2.

This configuration can correct driving of the stepping motor comparatively quickly with a simple structure without improving the manufacturing precision of the stepping motor.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-148510, filed Jul. 4, 2011 which is hereby incorporated by reference herein in its entirety.

1. A drive controlling apparatus for a stepping motor, the drive controlling apparatus comprising:
a driver configured to apply driving signals configured to excite a plurality of windings in the stepping motor; and
a controller configured to acquire a detection result of excitation currents that flow in the plurality of windings in the stepping motor, and to provide a feedback control over the driving signals applied by the driver so that a difference can be reduced between a first time difference and a second time difference, the first time difference being a period from a first reference time set in an excitation current waveform of the winding corresponding to a first drive channel to a time at which a set current value is provided, and the second time difference being a period from a second reference time corresponding to the first reference time and set in the excitation current waveform of the winding corresponding to the second drive channel to a time at which the set current value is provided.

2. A drive controlling apparatus for a stepping motor, the drive controlling apparatus comprising:
a driver configured to apply driving signals configured to excite a plurality of windings in the stepping motor; and
a controller configured to acquire a detection result of excitation currents that flow in the plurality of windings of the stepping motor and a rotating angle of the stepping motor based on the excitation currents in a plurality of periods, and to provide a feedback control over the driving signals applied by the driver so as to reduce a difference of the rotating angle of the stepping motor.

3. The drive controlling apparatus for the stepping motor according to claim 1, wherein the controller provides the feedback control over the driver based on the detection result when a driven speed of the stepping motor is a set speed.

4. The drive controlling apparatus for the stepping motor according to claim 1, wherein the controller provides the feedback control over the driver based on the detection result when the stepping motor has a driven speed in which a difference between the first time difference and the second time difference is larger than a set value.

5. The drive controlling apparatus for the stepping motor according to claim 2, wherein the controller provides the feedback control over the driver based on the detection result when the stepping motor has a driven speed in which a variation amount of the rotating angle of the stepping motor is larger than a set value.

6. The drive controlling apparatus for the stepping motor according to claim 1, wherein the controller provides the feedback control over the driver so as to change a phase difference or an amplitude ratio between the driving signals used to excite the plurality of windings.

7. The drive controlling apparatus for the stepping motor according to claim 1, wherein the controller provides the feedback control over the driver so as to shift a 180° position relative to a 0° position of the excitation current for each drive channel.

8. The drive controlling apparatus for the stepping motor according to claim 1, further comprising a current detector configured to detect the excitation currents that flow in the plurality of windings in the stepping motor.

9. An optical apparatus comprising a drive controlling apparatus for a stepping motor according to claim 1.

10. A drive controlling system comprising:
a drive controlling apparatus for a stepping motor according to claim 1; and
a measurement apparatus that includes a current detector configured to detect excitation currents that flow in a plurality of windings of the stepping motor.

11. A drive controlling method for a stepping motor, the drive controlling method comprising the steps of:
applying driving signals configured to excite a plurality of windings in the stepping motor; and
acquiring a detection result of excitation currents that flow in the plurality of windings of the stepping motor, and providing a feedback control over the driving signals so that a difference can be reduced between a first time difference and a second time difference, the first time difference being a period from a first reference time set in an excitation current waveform of the winding corresponding to a first drive channel to a time at which a set current value is provided, and the second time difference being a period from a second reference time corresponding to the first reference time and set in the excitation current waveform of the winding corresponding to the second drive channel to a time at which the set current value is provided.

12. A drive controlling method for a stepping motor, the drive controlling method comprising the steps of:
applying driving signals configured to excite a plurality of windings in the stepping motor; and
acquiring a detection result of excitation currents that flow in the plurality of windings of the stepping motor, and providing a feedback control over the driving signal so as to reduce a difference of a rotating angle of the stepping motor.
